(19) United States
(12) Patent Application Publication
(10) Pub. No.: US 2025/0323464 A1
(43) Pub. Date: Oct. 16, 2025

(54) ADAPTER FRAME STRUCTURE WITH MULTIPLE SETS OF RECEPTACLES

(71) Applicant: Dongguan Wanlvtong Electronics Co., Ltd., Dongguan (CN)

(72) Inventor: Liangzan LIN, Dongguan (CN)

(21) Appl. No.: 19/248,396

(22) Filed: Jun. 24, 2025

(30) Foreign Application Priority Data
Jan. 22, 2025 (CN) 202510097508.6

(51) Int. Cl. H01R 31/06

(52) U.S. Cl. CPC H01R 31/06

(57) ABSTRACT

A adapter frame structure, including a frame. The frame is provided with a plurality of main receptacles varying in type and a first auxiliary receptacle. The frame is slidably connected to a plug-pin assembly. The plug-pin assembly includes a plurality of plug-pin units arranged side by side in an arrangement direction of the plurality of main receptacles. Each of the plug-pin units includes a first extension-retraction part, which is provided with a terminal for plugging into an external socket. One of the plug-pin units corresponding to the first auxiliary receptacle includes a second extension-retraction part slidably provided on the frame.

### CROSS-REFERENCE TO RELATED APPLICATIONS

This application claims the benefit of priority from Chinese Patent Application No. 202510097508.6, filed on Jan. 22, 2025. The content of the aforementioned application, including any intervening amendments made thereto, is incorporated herein by reference in its entirety.

### TECHNICAL FIELD

This application relates to adapters, and more particularly to an adapter frame structure with multiple sets of receptacles.

### BACKGROUND

International travel or business trip has become increasingly popularized. Many types of electrical plugs have been designed to respectively adapt to different power outlets in different countries. Generally, the domestic electrical devices cannot be compatible with foreign sockets, causing significant inconvenience.

Therefore, to make the travel more convenient, an adapter that has many types of plugs fitting the power sockets in different regions and a panel with multiple types of receptacles has emerged on the market. For most of the commercially-available adapters, the receptacles are arranged on the same surface, such that only one electric device can be connected at a time, resulting in poor adaptability. Additionally, most of the existing adapters struggle with large size, resulting in poor portability.

Therefore, there is an urgent need to design and develop a structurally-compact adapter frame structure with multiple sets of receptacles to address at least one of the aforementioned technical issues.

### SUMMARY

An object of the disclosure is to provide a structurally-compact adapter frame structure with multiple sets of receptacles to overcome the defects in the prior art.

Technical solutions of the present disclosure are described as follows.

An adapter frame structure, comprising:
a frame;
wherein the frame is provided with a plurality of main receptacles varying in type and a first auxiliary receptacle;
the plurality of main receptacles are provided on a first side of the frame;
the first auxiliary receptacle is provided on a second side of the frame adjacent to the first side of the frame;
the plurality of main receptacles are arranged side by side; and the first auxiliary receptacle is located at a first end along an extension line of an arrangement direction of the plurality of main receptacles;
the frame is slidably connected to a plug-pin assembly, and the plug-pin assembly is configured to reciprocate in a direction perpendicular to the arrangement direction of the plurality of main receptacles;
the plug-pin assembly comprises a plurality of plug-pin units arranged side by side in the arrangement direction of the plurality of main receptacles; each of the plurality of plug-pin units comprises a first extension-retraction part; and the first extension-retraction part is provided with a terminal for engagement with an external socket;
an orthographic projection of the first auxiliary receptacle in a direction toward the plug-pin assembly is located on an outermost one of the plurality of plug-pin units;
the outermost one of the plurality of plug-pin units comprises a second extension-retraction part slidably provided on the frame; and
a portion of the terminal on the outermost one of the plurality of plug-pin units extending out of the frame is larger than a portion of terminals of remaining plug-pin units among the plurality of plug-pin units extending out of the frame in length.

In some embodiments, the frame is further provided with two first conductive metal components, and each of the two first conductive metal components is corresponding to the plurality of main receptacles and the first auxiliary receptacle;
the two first conductive metal components are arranged side by side, and are respectively corresponding to a live wire and a neutral wire;
each of the two first conductive metal components is configured to extend in a predetermined direction; each of the two first conductive metal components is provided with a plurality of main plug-in points; and the plurality of main plug-in points are arranged side by side along the predetermined direction, and are respectively corresponding to the plurality of main receptacles;
an end of each of the two first conductive metal components is provided with a first auxiliary plug-in point corresponding to the first auxiliary receptacle; and
an opening of the first auxiliary plug-in point is oriented toward the predetermined direction.

In some embodiments, each of the two first conductive metal components comprises a main body;
the plurality of main plug-in points are provided on the main body;
a first end of the main body extending along the predetermined direction is provided with a first protruding portion protruding upward and extending in the predetermined direction;
the first auxiliary plug-in point is provided on the first protruding portion; and
the opening of the first auxiliary plug-in point is configured to open in the predetermined direction.

In some embodiments, the frame is further provided with two second conductive metal components respectively corresponding to the two first conductive metal components;
the two second conductive metal components are respectively corresponding to the neutral line and the live line;
a conductive element is provided between each of the two first conductive metal components and a corresponding one of the two second conductive metal components; and
the plurality of plug-pin units are configured to slide along the frame toward the two second conductive metal components, such that the first extension-retraction part is engaged with one of the two second conductive metal components to electrically connect the one of the two first conductive metal components to the terminal.

In some embodiments, one of the plurality of plug-pin units corresponding to the first auxiliary plug-in point is a European plug-pin unit; and
an embedding structure is provided between the first extension-retraction part and the second extension-retraction part, such that the first extension-retraction part is at least partially embedded within the second extension-retraction part in response to a case that the European plug-pin unit is retracted into the frame.

In some embodiments, the embedding structure comprising:
an embedding portion;
a pushing portion;
a base; and
a side wall;
wherein the embedding portion is provided on the first extension-retraction part, and is configured to protrude toward the second extension-retraction part;
the pushing portion is configured to extend toward both ends in a length direction of the first extension-retraction part;
the terminal is provided on the embedding portion;
a retaining pin is provided on a side of the first extension-retraction part, and the retaining pin and a surface of the pushing portion facing toward the second extension-retraction part are not located on the same horizontal plane;
the base is provided at an end of the second extension-retraction part;
the side wall is formed at a side edge of the base, and is configured to extend in a direction away from the base;
a chamber is provided at an end of the base facing toward the first extension-retraction part, and is configured to accommodate the embedding portion; and a bottom of the chamber is provided with a through hole for the terminal to extend out; and
the side wall is provided with a groove configured to receive the retaining pin for limited sliding.

In some embodiments, the frame comprises a first frame portion and a second frame portion arranged in a vertical direction;
a plurality of guide posts are arranged between the first frame portion and the second frame portion for support;
the two first conductive metal components are in snap-fit connection with the first frame portion; and the two second conductive metal components are in snap-fit connection with the second frame portion;
the conductive element is configured for electrical connection; and
the first extension-retraction part is slidably connected to the plurality of guide posts.

In some embodiments, the number of the conductive element is two; two ends of each of two conductive elements are respectively connected to a corresponding one of the two first conductive metal components and a corresponding one of the two second conductive metal components, such that the two first conductive metal components are electrically connected to the two second conductive metal components; and
one of the two conductive elements is formed by the plurality of guide posts, and the other of the two conductive elements is formed by a fuse.

In some embodiments, the frame is further provided with a second auxiliary receptacle; and the second auxiliary receptacle is provided on a third side of the frame corresponding to a position of the first auxiliary receptacle;
the second auxiliary receptacle is located at a second end of the extension line of the arrangement direction of the plurality of main receptacles, and is corresponding to the first auxiliary receptacle;
the first auxiliary receptacle and the second auxiliary receptacle are configured in the same type or different types;
a second end of the main body extending along the predetermined direction is provided with a second protruding portion protruding upward and extending in the predetermined direction; and
the second protruding portion is provided with a second auxiliary plug-in point corresponding to the second auxiliary receptacle.

In some embodiments, the frame is further provided with a third auxiliary receptacle; the third auxiliary receptacle is provided on a fourth side of the frame, and the fourth side of the frame is adjacent to the second side of the frame; and the third auxiliary receptacle is located on a side of the plurality of main receptacles;
the third auxiliary receptacle and the first auxiliary receptacle are configured in the same type or different types;
the main body of one of the two first conductive metal components is provided with an extending portion extending in a direction perpendicular to the predetermined direction; and the main body of the other of the two first conductive metal components is provided with a connecting beam in parallel with the extending portion;
the connecting beam is configured to cross the main body provided with the extending portion, and extend to a side of the main body provided with the extending portion; and
free ends of the extending portion and the connecting beam are each provided with a third auxiliary plug-in point corresponding to the third auxiliary receptacle.

Compared to the prior art, the present disclosure has the following beneficial effects.

Regarding the adapter frame structure provided herein, the first auxiliary receptacle is located at the first end of the extension line of the arrangement direction of the plurality of main receptacles, and is located on the second side of the frame, thereby providing additional plug-in points to allow at least two electrical appliances to share the same socket, enhancing overall usability. At the same time, the two first conductive metal components corresponding to a main receptacle panel and an auxiliary receptacle panel are arranged in the arrangement direction of the plurality of main receptacles, allowing the main plug-in point and the first auxiliary plug-in point to be arranged side by side along a length direction of the first conductive metal component. This configuration ensures that the two first conductive metal components exhibits high strength and good electrical conductivity. Furthermore, the European plug-pin unit is provided with the embedding structure, such that when the European plug-pin unit retracts into the frame, an overall height of the European plug-pin unit is reduced, thus enabling the entire socket structure to remain compact and maintain a reduced height profile.

### BRIEF DESCRIPTION OF THE DRAWINGS

FIG. 1 is a structural diagram of an adapter frame structure according to an embodiment of the present disclosure;

FIG. 2 is a structural diagram of a single plug-pin unit protruding from a frame according to an embodiment of the present disclosure;

FIG. 3 is a structural diagram of multiple plug-pin units protruding from the frame according to an embodiment of the present disclosure;

FIG. 4 is an exploded view of the frame and a plug-pin assembly according to an embodiment of the present disclosure;

FIG. 5 is a structural diagram of a first conductive metal component according to an embodiment of the present disclosure;

FIG. 6 is an exploded view of the plug-pin assembly according to an embodiment of the present disclosure;

FIG. 7 is an exploded view of a European plug-pin unit according to an embodiment of the present disclosure; and

FIG. 8 is a structural diagram of an adapter using the frame structure according to an embodiment of the present disclosure.

In the figures: 111—main receptacle; 121—first auxiliary receptacle; 200—frame; 210—first conductive metal component; 220—second conductive metal component; 211—main plug-in point; 212—first auxiliary plug-in point; 300—plug-pin assembly; 310—plug-pin unit; 201—first frame portion; 202—second frame portion; 203—guide post; 204—conductive element; 221—clamping position; 213—main body; 214—first protruding portion; 311—first extension—retraction part; 312—toggle end; 313—terminal; 314—plug-in part; 310a—European plug-pin unit; 316—embedding portion; 317—pushing portion; 318—retaining pin; 320—second extension-retraction part; 321—base; 322—chamber; 323—side wall; 324—groove; 131—second auxiliary receptacle; 141—third auxiliary receptacle; 215—second protruding portion; 216—second auxiliary plug-in point; 217—third auxiliary plug-in point; 218—extending portion; 219—connecting beam; 100—housing; 110—main receptacle panel; 120—first auxiliary receptacle panel; and 140—third auxiliary receptacle panel.

### DETAILED DESCRIPTION OF EMBODIMENTS

In order to facilitate the understanding of technical solutions of the present disclosure, the present disclosure will be further described in conjunction with the embodiments and the accompanying drawings. It should be noted that the embodiments are merely exemplary, and are not intended to limit the present disclosure. A detailed description of the present disclosure will be provided below in conjunction with the accompanying drawings.

### EXAMPLE 1

Provided herein is a structurally-compact adapter frame structure with multiple sets of receptacles, which serves as an essential component of an adapter. The frame structure is provided with a main receptacle 111 and a first auxiliary receptacle 121, which are respectively provided on two adjacent sides of a frame. In this embodiment, multiple sets of main receptacles 111 are arranged side by side, where the multiple sets of main receptacles 111 are in different types. Specifically, the multiple sets of main receptacles 111 includes at least one two-pole jack and three-pole jack. The first auxiliary receptacle 121 is provided on a side extending in an arrangement direction of the plurality of sets of main receptacles 111. Through the above arrangement, the frame structure enables additional plug-in points, thereby allowing more electrical devices to be simultaneously connected and powered.

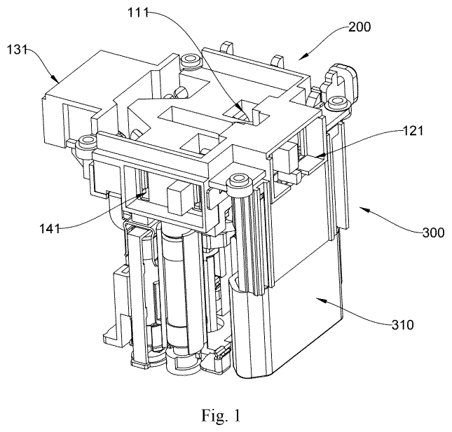

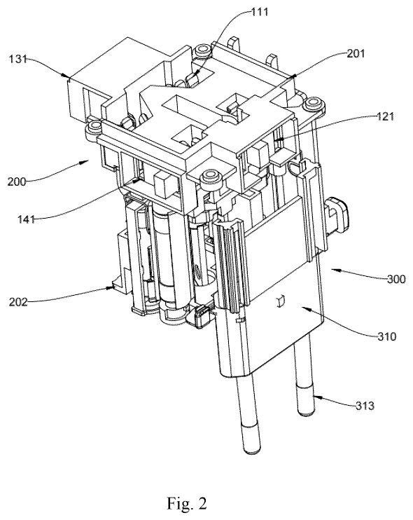

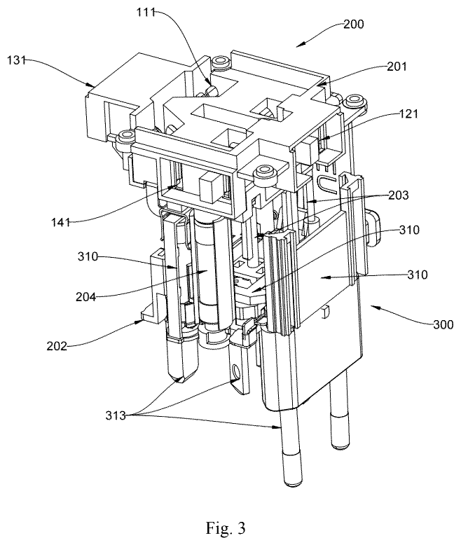

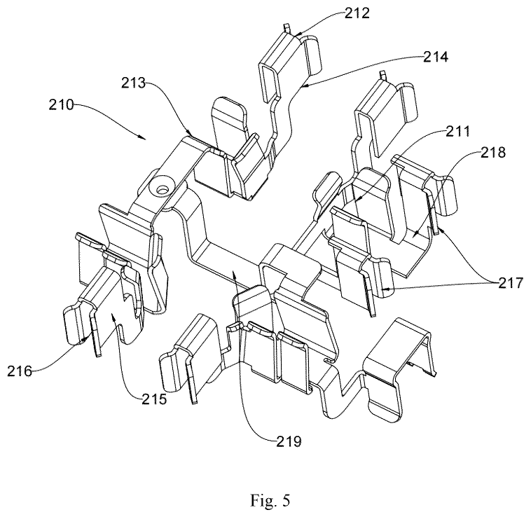

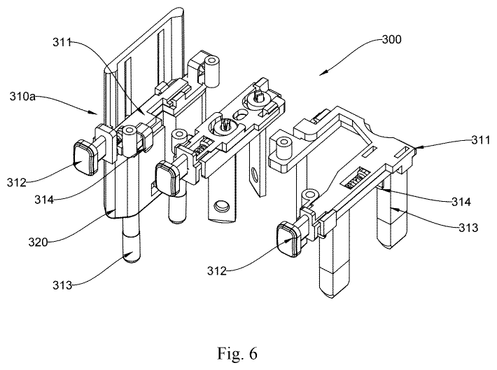

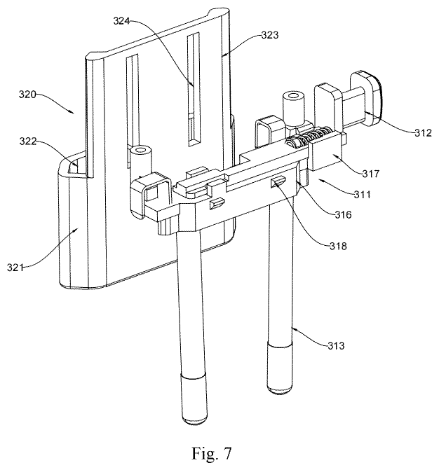

In this embodiment, as illustrated in FIGS. 1-7, an adapter frame structure is provided. The adapter frame structure includes a frame 200. The frame 200 is provided with a plurality of main receptacles 111 varying in type and a first auxiliary receptacle 121. The plurality of main receptacles 111 are provided on a first side of the frame 200. The first auxiliary receptacle 121 is provided on a second side of the frame 200 adjacent to the first side of the frame 200. The plurality of main receptacles 111 are arranged side by side. The first auxiliary receptacle 121 is located at a first end along an extension line of an arrangement direction of the plurality of main receptacles 111. The frame 200 is slidably connected to a plug-pin assembly 300. The plug-pin assembly 300 is configured to reciprocate in a direction perpendicular to the arrangement direction of the plurality of main receptacles 111. The plug-pin assembly 300 includes a plurality of plug-pin units 310 arranged side by side in the arrangement direction of the plurality of main receptacles 111. Each of the plurality of plug-pin units 310 includes a first extension-retraction part 311. The first extension-retraction part 311 is provided with a terminal 313 for engagement with an external socket. An orthographic projection of the first auxiliary receptacle 121 in a direction toward the plug-pin assembly 300 is located on an outermost one of the plurality of plug-pin units 310. The outermost one of the plurality of plug-pin units 310 includes a second extension-retraction part 320 slidably provided on the frame 200. A portion of the terminal 313 on the outermost plug-pin unit 310 corresponding to the first auxiliary receptacle 121 extending out of the frame 200 is larger than a portion of terminals 313 of remaining plug-pin units among the plurality of plug-pin units 310.

In this embodiment, the plurality of plug-pin units 310 are configured to extend outward from or retract into the frame 200. After extending outward from the frame 200, the plurality of plug-pin units 310 are engaged with an external socket. In this state, electrical connection can be made not only through the plurality of main receptacles 111, but also through the first auxiliary receptacle 121, thereby providing additional plug-in points and improving the usability of the socket.

In this embodiment, the frame 200 is further provided with two first conductive metal components 210, and each of the two first conductive metal components 210 is corresponding to the plurality of main receptacles 111 and the first auxiliary receptacle 121. The two first conductive metal components 210 are arranged side by side, and are respectively corresponding to a live wire and a neutral wire. Each of the two first conductive metal components 210 is configured to extend in a predetermined direction. In this embodiment, the predetermined direction is the arrangement direction of the plurality of main receptacles 111. Each of the two first conductive metal components 210 is provided with a plurality of main plug-in points 211. The plurality of main plug-in points are arranged side by side along the predetermined direction, and are respectively corresponding to the plurality of main receptacles 111. An end of each of the two first conductive metal components 210 is provided with a first auxiliary plug-in point 212 corresponding to the first auxiliary receptacle 121. An opening of the first auxiliary plug-in point 212 is oriented toward the predetermined direction.

In this embodiment, the two first conductive metal components 210 are configured as two mirror-symmetrical elements, respectively corresponding to the live wire and the neutral wire. When an electrical appliance is plugged into the two first conductive metal components 210, an electrical path can be formed between the live and neutral wires. The two first conductive metal components 210 are configured to extend in the predetermined direction. The first auxiliary plug-in point 212 is provided at the end of each of the two first conductive metal components 210, such that the first auxiliary plug-in point 212 is located along an extension line of an arrangement direction of the plurality of main plug-in points 211 in the predetermined direction.

Specifically, each of the two first conductive metal components 210 includes a main body 213. The plurality of main plug-in points 211 are provided on the main body 213. A first end of the main body 213 extending along the predetermined direction is provided with a first protruding portion 214 protruding upward and extending in the predetermined direction. The first auxiliary plug-in point 212 is provided on the first protruding portion 214. The opening of the first auxiliary plug-in point 212 is configured to open in the predetermined direction.

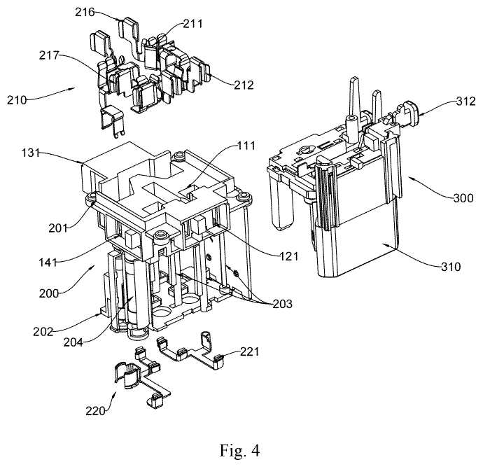

In this embodiment, each of the two the first conductive metal components 210 includes the main body 213. The plurality of main plug-in points 211 are provided on the main body 213. The first end of the main body 213 extending along the predetermined direction is provided with the first protruding portion 214 protruding upward and extending in the predetermined direction. The first auxiliary plug-in point 212 is provided on the first protruding portion 214. The opening of the first auxiliary plug-in point 212 is configured to open in the predetermined direction. As shown in FIG. 4, each of the two first conductive metal components 210 is configured in an elongated strip shape, such that the plurality of main plug-in points 211 and the first auxiliary plug-in point 212 are arranged in a length direction of the first conductive metal component 210. This configuration enables the first auxiliary plug-in point 212 to be positioned at an end of the first conductive metal component 210. During the manufacturing process of the first conductive metal component 210, the first conductive metal component 210 can be fabricated from a single copper material by stamping and bending, thereby simplifying the processing method while providing improved structural strength and electrical conductivity of the first conductive metal component 210. In contrast, if the direction of the first auxiliary plug-in point 212 is not aligned with the extension line of the arrangement direction of the plurality of main plug-in points 211, the two first conductive metal components 210 would each need to be separately formed with a laterally extended portion bent toward a side More significantly, one of the two first conductive metal components 210 would require a longer laterally extended portion, which wound further need to be bent upward or downward to form a side-facing plug-in point. This would result in two separate planes at different heights between the extended portion and the main body of the first conductive component 210, thus complicating the structure and increasing the height of the first conductive metal component 210. Furthermore, the extended portion would require extra solder joints for reinforcement, thereby reducing the overall structural strength of the first conductive components 210.

In this embodiment, the frame 200 is further provided with two second conductive metal components 220 respectively corresponding to the two first conductive metal components 210. The two second conductive metal components 220 are respectively corresponding to the neutral line and the live line. A conductive element 204 is provided between each of the two first conductive metal components 210 and a corresponding one of the two second conductive metal components 220. The plurality of plug-pin units 310 are configured to slide along the frame 200 toward the two second conductive metal components 220, such that the first extension-retraction part 311 is engaged with one of the two second conductive metal components 220 to electrically connect the first conductive metal component 210 to the terminal 313.

By means of the two second conductive metal components 220, after the plurality of plug-pin units 310 slide along the frame 200 and the terminal 313 extends outward, the terminal 313 can be engaged with the external socket to become energized. At this time, the first extension-retraction part 311 is engaged with one of the two second conductive metal components 220 to electrically connect the terminal 313 to the second conductive metal component 220, which in turn becomes energized. Through the conductive element 204, the first conductive metal components 210 are also energized, enabling electrical power supply to appliances plugged into the main receptacles 111 or the first auxiliary receptacle 121.

In this embodiment, one of the plurality of plug-pin units 310 corresponding to the first auxiliary plug-in point 212 is a European plug-pin unit 310a. An embedding structure is provided between the first extension-retraction part 311 and the second extension-retraction part 320, such that the first extension-retraction part 311 is at least partially embedded within the second extension-retraction part 320 in response to a case that the European plug-pin unit 310a is retracted into the frame 200.

In this embodiment, since the European plug-pin unit 310a is arranged at a position corresponding to the first auxiliary plug-in point 212 (the first auxiliary receptacle 121), when the first extension-retraction part 311 and the second extension-retraction part 320 are retracted inside the frame 200, at least a portion of the first extension-retraction part 311 can be embedded within the second extension-retraction part 320 via the embedding structure. This arrangement reduces the overall height dimension of the European plug-pin unit 310a, ensures a more compact structure of the frame, and thereby guarantees a compact and smaller-sized adapter structure.

Specifically, the embedding structure includes an embedding portion 316, a pushing portion 317, a base 321 and a side wall 323. The embedding portion 316 is provided on the first extension-retraction part 311, and is configured to protrude toward the second extension-retraction part 320. The pushing portion 317 is configured to extend toward both ends in a length direction of the first extension-retraction part 311. The terminal 313 is provided on the embedding portion 316. A retaining pin 318 is provided on a side of the first extension-retraction part 311. The retaining pin 318 and a surface of the pushing portion 317 facing toward the second extension-retraction part 320 are not located on the same horizontal plane. The base 321 is provided at an end of the second extension-retraction part 320. The side wall 323 is formed at a side edge of the base 321, and is configured to extend in a direction away from the base 321. A chamber 322 is provided at an end of the base 321 facing toward the first extension-retraction part 311, and is configured to accommodate the embedding portion 316. A bottom of the chamber 322 is provided with a through hole for the terminal 313 to extend out. The side wall 323 is provided with a groove 324 configured to receive the retaining pin for limited sliding.

In the European plug-pin unit 310a, the first extension-retraction part 311 is configured as the embedding portion 316 and the pushing portion 317, such that when the terminal 313 is fixed on the embedding portion 316, the embedding portion 316 has sufficient volume to meet the installation requirements of the terminal 313 and ensure insulation between terminals 313. When the European plug-pin unit 310a is pushed outward, the embedding portion 316 extends into the chamber 322 of the second extension-retraction part 320. At the same time, the pushing portion 317 abuts against an end of the base 321 of the second extension-retraction part 320, thereby pushing the second extension-retraction part 320 to extend outward. When the European plug-pin unit 310a is retracted into an installation space 101, pulling a toggle end 312 causes the retaining pin 318 to slide within the groove 324. Once the retaining pin 318 is limited by a top of the groove 324, the continued pulling action drives the second extension-retraction part 320 to retract into the installation space 101. Through the above structure, when the European plug-pin unit 310a is retracted into the installation space 101, the overall structure becomes more compact, thereby ensuring that the height dimension of the socket does not increase.

To facilitate reciprocal sliding of the plurality of plug-pin units 310 along the frame 200, the toggle end 312 is provided at an end of the first extension-retraction part 311 in a length direction of the first extension-retraction part 311. The toggle end 312 is configured to extend outward from the frame 200. The first extension-retraction part 311 is provided with a plug-in part 314. One end of the plug-in part 314 is connected to the terminal 313, and the other end of the plug-in part 314 is plugged into one of the two second conductive metal components 220. In this embodiment, the toggle end 312 extends beyond the frame 200, such that when the toggle end 312 is manipulated, it drives the first extension-retraction part 311 to move, thereby causing the terminal 313 to extend or retract accordingly. Meanwhile, the first extension-retraction part 311 is provided with the plug-in part 314. When the plurality of plug-pin units 310 move outward along the frame 200, and the terminal 313 extends beyond the frame 200, the first extension-retraction part 311 is plugged into the two second conductive metal components 220 via the plug-in part 314, thereby establishing an electrical connection between the terminal 313 and the two second conductive metal components 220. Furthermore, when the terminal 313 is plugged into the external socket, the first conductive metal components 210 are energized through the second conductive metal components 220 and the conductive member 204.

In this embodiment, the frame 200 includes a first frame portion 201 and a second frame portion 202 arranged in a vertical direction. A plurality of guide posts 203 are provided between the first frame portion 201 and the second frame portion 202 for support. The two first conductive metal components 210 are in snap-fit connection with the first frame portion 201. The two second conductive metal components 220 are in snap-fit connection with the second frame portion 202. The conductive element 204 is configured for electrical connection. The first extension-retraction part 311 is slidably connected to the plurality of guide posts 203. In this embodiment, the first frame portion 201 is provided with a first mounting groove having a predetermined shape. The two first conductive metal components 210 are in snap-fit connection with the first mounting groove. The second frame portion 202 is provided with a second mounting groove (not shown in the figures) to facilitate installation of the two second conductive metal components 220.

The number of the conductive element 204 is two. Two ends of each of two conductive elements 204 are respectively connected to a corresponding one of the two first conductive metal components 210 and a corresponding one of the two second conductive metal components 220, such that the two first conductive metal components 210 are electrically connected to the two second conductive metal components 220. One of the two conductive elements 204 is formed by the plurality of guide posts 203, and the other of the two conductive elements 204 is formed by a fuse.

Specifically, one of the plurality of guide posts 203 is made of a metal, with its two ends respectively connected to the first conductive metal component 210 and the second conductive metal component 220 corresponding to the neutral line, thereby electrically connecting the first conductive metal component 210 and the second conductive metal component 220. In this case, the first extension-retraction part 311 is slidably connected to the plurality of guide posts 203. Two ends of the conductive element 204 formed by the fuse respectively connected to the first conductive metal component 210 and the second conductive metal component 220 corresponding to the live line, thereby providing an overcurrent protection mechanism. When an overvoltage or overcurrent condition occurs, the fuse can break the circuit to ensure electrical safety.

### EXAMPLE 2

In this embodiment, the technical solution is the same as that of Example 1 described above, except that, in order to increase the socket's capacity, a second auxiliary receptacle 131 is provided for additional plug-in connection. Specifically, as shown in FIGS. 1-5, the frame 200 is further provided with the second auxiliary receptacle 131. The second auxiliary receptacle 131 is provided on a third side of the frame 200 corresponding to a position the first auxiliary receptacle 121. The second auxiliary receptacle 131 is arranged at a second end of the extension line of the arrangement direction of the plurality of main receptacles, and is corresponding to the first auxiliary receptacle 121. The first auxiliary receptacle 121 and the second auxiliary receptacle 131 are configured in the same type or different types. A second end of the main body 213 extending along the predetermined direction is provided with a second protruding portion 215 protruding upward and extending in the predetermined direction. The second protruding portion 215 is provided with a second auxiliary plug-in point 216 corresponding to the second auxiliary receptacle 131.

That is, the second auxiliary receptacle 131 is provided on the third side of the frame 200 opposite to the second side of the frame 200 on which the first auxiliary receptacle 121 is located. In this way, three separate sockets can be plugged into the main receptacles 111, the first auxiliary receptacle 121, and the second auxiliary receptacle 131, thereby providing additional plug-in points to meet the user's power supply demands. Meanwhile, when configuring the second auxiliary plug-in point 216 corresponding to the second auxiliary receptacle 131, the second protruding portion 215 is provided at the second end of the main body 213 extending along the predetermined direction. The second auxiliary plug-in point 216 is provided on the second protruding portion 215, such that the first auxiliary plug-in point 212, the main plug-in point 211, and the second auxiliary plug-in point 216 are aligned in the predetermined direction. This configuration allows the first conductive metal components 210 to be integrally formed from a single piece of copper material through stamping or other processing methods, thereby ensuring the reliability and safety performance of the first conductive metal components 210.

### EXAMPLE 3

In this embodiment, the technical solution is the same as that of Example 1 described above, except that, to further increase the plug-in capacity of the socket, a third auxiliary receptacle 141 is provided on the basis of Example 1. Specifically, in this embodiment, the frame 200 is further provided with the third auxiliary receptacle 141 located on a third side of the frame 200. The third side of the frame 200 is adjacent to the second side of the frame 200. The third auxiliary receptacle 141 is located on a side of the plurality of the main receptacles 111. The third auxiliary receptacle 141 and the first auxiliary receptacle 121 are configured in the same type or different types. The main body 213 of one of the two first conductive metal components 210 is provided with an extending portion 218 extending in a direction perpendicular to the predetermined direction. The main body 213 of the other of the two first conductive metal components 210 is provided with a connecting beam 219 in parallel with the extending portion 218. The connecting beam 219 is configured to cross the main body provided with the extending portion 218, and extend to a side of the main body provided with the extending portion 218. Free ends of the extending portion 218 and the connecting beam 219 are each provided with a third auxiliary plug-in point 217 corresponding to the third auxiliary receptacle 141.

That is to say, in this embodiment, by means of the plurality of main receptacles 111, the first auxiliary receptacle 121, and the third auxiliary receptacle 141, the usability of the socket is improved, allowing more plug-in points to be provided for the user. The third auxiliary receptacle 141 is provided on the third side of the frame 200 opposite to a position toggle end 312 of the plug-pin unit 310, thereby increasing the available insertion positions without affecting the operation of the toggle end 312.

### EXAMPLE 4

In this embodiment, in order to further improve the usability of the socket, a third auxiliary receptacle 141 is provided on the basis of the technical solution of Example 2. That is, the frame 200 is provided with the plurality of main receptacles 111, the first auxiliary receptacle 121, the second auxiliary receptacle 131 and the third auxiliary receptacle 141. In other words, auxiliary receptacles are provided on the remaining three sides of the frame 200, thereby further enhancing the usability of the socket.

It should be noted that the first auxiliary receptacle 121, the second auxiliary receptacle 131, and the third auxiliary receptacle 141 may be configured in the same type or different types. In other words, the three auxiliary receptacles may respectively adopt receptacle configurations corresponding to European, British, Australian, Indian, Japanese, Chinese or other standard specifications, thereby facilitating user convenience during travel.

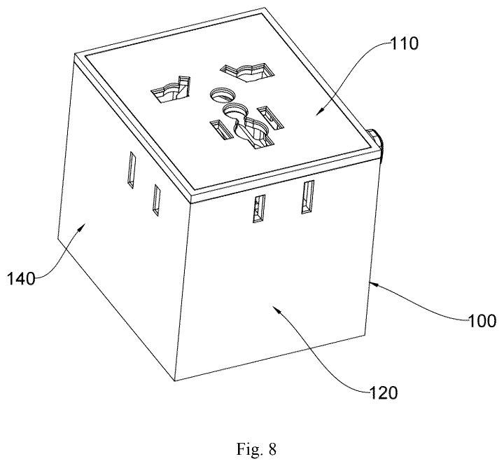

As shown in FIG. 8, three receptacle panels are provided on a housing 100 of an adapter employing the frame structure provided herein. Specifically, a main receptacle panel 110 is provided on a first side of the housing 100. A first auxiliary receptacle panel 120 is provided on a second side of the housing 100. A second auxiliary receptacle panel is provided on a third side of the housing 100. A third auxiliary receptacle panel 140 is provided on a fourth side of the housing 100. The second side of the housing 100, the third side of the housing 100 and the fourth side of the housing 100 are each adjacent to the first side of the housing 100. This configuration provides multiple receptacle locations, allowing two electrical devices to be plugged into the socket simultaneously.

Described above are merely preferred embodiments of the present disclosure, and are not intended to limit the scope of the present disclosure. Though the present disclosure has been elaborated above with reference to the embodiments, those skilled in the art can still make various changes or modifications to the technical solutions disclosed herein. It should be understood that those changes and modifications made without departing from the scope of the present disclosure shall fall within the scope of the present disclosure defined by the appended claims.

What is claimed is:

1. An adapter frame structure, comprising:
a frame;
wherein the frame is provided with a plurality of main receptacles varying in type and a first auxiliary receptacle;
the plurality of main receptacles are provided on a first side of the frame;
the first auxiliary receptacle is provided on a second side of the frame adjacent to the first side of the frame;
the plurality of main receptacles are arranged side by side; and the first auxiliary receptacle is located at a first end along an extension line of an arrangement direction of the plurality of main receptacles;
the frame is slidably connected to a plug-pin assembly, and the plug-pin assembly is configured to reciprocate in a direction perpendicular to the arrangement direction of the plurality of main receptacles;
the plug-pin assembly comprises a plurality of plug-pin units arranged side by side in the arrangement direction of the plurality of main receptacles; each of the plurality of plug-pin units comprises a first extension-retraction part; and the first extension-retraction part is provided with a terminal for engagement with an external socket;
an orthographic projection of the first auxiliary receptacle in a direction toward the plug-pin assembly is located on an outermost one of the plurality of plug-pin units;
the outermost one of the plurality of plug-pin units comprises a second extension-retraction part slidably provided on the frame; and
a portion of the terminal on the outermost one of the plurality of plug-pin units extending out of the frame is larger than a portion of terminals of remaining plug-pin units among the plurality of plug-pin units extending out of the frame in length.

2. The adapter frame structure of claim 1, wherein the frame is further provided with two first conductive metal components, and each of the two first conductive metal components is corresponding to the plurality of main receptacles and the first auxiliary receptacle;
the two first conductive metal components are arranged side by side, and are respectively corresponding to a live wire and a neutral wire;
each of the two first conductive metal components is configured to extend in a predetermined direction; each of the two first conductive metal components is provided with a plurality of main plug-in points; and the plurality of main plug-in points are arranged side by side along the predetermined direction, and are respectively corresponding to the plurality of main receptacles;
an end of each of the two first conductive metal components is provided with a first auxiliary plug-in point corresponding to the first auxiliary receptacle; and
an opening of the first auxiliary plug-in point is oriented toward the predetermined direction.

3. The adapter frame structure of claim 2, wherein each of the two first conductive metal components comprises a main body;
the plurality of main plug-in points are provided on the main body;
a first end of the main body extending along the predetermined direction is provided with a first protruding portion protruding upward and extending in the predetermined direction; and
the first auxiliary plug-in point is provided on the first protruding portion.

4. The adapter frame structure of claim 3, wherein the frame is further provided with two second conductive metal components respectively corresponding to the two first conductive metal components;
the two second conductive metal components are respectively corresponding to the neutral line and the live line;
a conductive element is provided between each of the two first conductive metal components and a corresponding one of the two second conductive metal components; and
the plurality of plug-pin units are configured to slide along the frame toward the two second conductive metal components, such that one of the two second conductive metal components is electrically connected to the terminal through the first extension-retraction part.

5. The adapter frame structure of claim 2, wherein one of the plurality of plug-pin units corresponding to the first auxiliary plug-in point is a European plug-pin unit; and
an embedding structure is provided between the first extension-retraction part and the second extension-retraction part, such that the first extension-retraction part is at least partially embedded within the second extension-retraction part in response to a case that the European plug-pin unit is retracted into the frame.

6. The adapter frame structure of claim 5, wherein the embedding structure comprising:
an embedding portion;
a pushing portion;
a base; and
a side wall;
wherein the embedding portion is provided on the first extension-retraction part, and is configured to protrude toward the second extension-retraction part;
the pushing portion is configured to extend toward both ends in a length direction of the first extension-retraction part;
the terminal is provided on the embedding portion;
a retaining pin is provided on a side of the first extension-retraction part, and the retaining pin and a surface of the pushing portion facing toward the second extension-retraction part are not located on the same horizontal plane;
the base is provided at an end of the second extension-retraction part;
the side wall is formed at a side edge of the base, and is configured to extend in a direction away from the base;
a chamber is provided at an end of the base facing toward the first extension-retraction part, and is configured to accommodate the embedding portion; and a bottom of the chamber is provided with a through hole for the terminal to extend out; and
the side wall is provided with a groove configured to receive the retaining pin for limited sliding.

7. The adapter frame structure of claim 4, wherein the frame comprises a first frame portion and a second frame portion arranged in a vertical direction;
a plurality of guide posts are arranged between the first frame portion and the second frame portion for support;
the two first conductive metal components are in snap-fit connection with the first frame portion; and the two second conductive metal components are in snap-fit connection with the second frame portion; and
the first extension-retraction part is slidably connected to the plurality of guide posts.

8. The adapter frame structure of claim 7, wherein the number of the conductive element is two; two ends of each of two conductive elements are respectively connected to a corresponding one of the two first conductive metal components and a corresponding one of the two second conductive metal components, such that the two first conductive metal components are electrically connected to the two second conductive metal components; and
one of the two conductive elements is formed by the plurality of guide posts, and the other of the two conductive elements is formed by a fuse.

9. The adapter frame structure of claim 3, wherein the frame is further provided with a second auxiliary receptacle; and the second auxiliary receptacle is provided on a third side of the frame corresponding to a position of the first auxiliary receptacle;
the second auxiliary receptacle is located at a second end of the extension line of the arrangement direction of the plurality of main receptacles, and is corresponding to the first auxiliary receptacle;
the first auxiliary receptacle and the second auxiliary receptacle are configured in the same type or different types;
a second end of the main body extending along the predetermined direction is provided with a second protruding portion protruding upward and extending in the predetermined direction; and
the second protruding portion is provided with a second auxiliary plug-in point corresponding to the second auxiliary receptacle.

10. The adapter frame structure of claim 9, wherein the frame is further provided with a third auxiliary receptacle; the third auxiliary receptacle is provided on a fourth side of the frame, and the fourth side of the frame is adjacent to the second side of the frame; and the third auxiliary receptacle is located on a side of the plurality of main receptacles;
the third auxiliary receptacle and the first auxiliary receptacle are configured in the same type or different types;
the main body of one of the two first conductive metal components is provided with an extending portion extending in a direction perpendicular to the predetermined direction; and the main body of the other of the two first conductive metal components is provided with a connecting beam in parallel with the extending portion;
the connecting beam is configured to cross the main body provided with the extending portion, and extend to a side of the main body provided with the extending portion; and
free ends of the extending portion and the connecting beam are each provided with a third auxiliary plug-in point corresponding to the third auxiliary receptacle.
